(19) United States
(12) Patent Application Publication
(10) Pub. No.: US 2015/0200892 A1
(43) Pub. Date: Jul. 16, 2015

(54) SYSTEMS AND METHODS FOR AUTOMATICALLY PRESENTING REMINDERS

(71) Applicant: Google Inc., (US)

(72) Inventor: Vinod Kumar RAMACHANDRAN, Sunnyvale, CA (US)

(73) Assignee: Google Inc., Mountain View, CA (US)

(21) Appl. No.: 13/626,848

(22) Filed: Sep. 25, 2012

(51) Int. Cl. H04L 12/58

(52) U.S. Cl. CPC H04L 51/14; H04L 51/32

(57) ABSTRACT

Systems and methods for automatically presenting reminders are provided. In some aspects, a system includes a task module configured to determine a reminder specified by a user. The system also includes an association module configured to automatically determine one or more events relevant to the reminder without requiring the user to specify the one or more events relevant to the reminder. The system also includes a detection module configured to detect an occurrence of the one or more events. The system also includes a surfacing module configured to automatically present the reminder via an electronic device based on the occurrence of the one or more events.

### FIELD

The subject technology generally relates to the presentation of reminders and, in particular, relates to systems and methods for automatically presenting reminders.

### BACKGROUND

After a user records a reminder (e.g., creates an item on a task list or other list), the reminder is typically presented to the user either at a default time or at a specific time indicated by the user. However, there may be many events that occur during which the presentation of the reminder may be more relevant than just presenting the reminder at either the default time or the specific time indicated by the user. Thus, if the default time or the specific time does not match up with when the relevant events occur, the user is not presented with the reminder even though it may be more relevant to do so then. This can be especially problematic if a reminder is associated with many relevant events, as it would be difficult for the user to specify all the different times that the reminder should be presented.

### SUMMARY

According to various aspects of the subject technology, a system for automatically presenting reminders is provided. The system comprises a task module configured to determine a reminder specified by a user. The system also comprises an association module configured to automatically determine one or more events relevant to the reminder without requiring the user to specify the one or more events relevant to the reminder. The system also comprises a detection module configured to detect an occurrence of the one or more events. The system also comprises a surfacing module configured to automatically present the reminder via an electronic device based on the occurrence of the one or more events.

According to various aspects of the subject technology, a computer-implemented method for automatically presenting reminders is provided. The method comprises determining a reminder specified by a user. The method also comprises automatically determining one or more events relevant to the reminder without requiring the user to specify the one or more events relevant to the reminder. The method also comprises detecting an occurrence of the one or more events. The method also comprises automatically presenting the reminder via an electronic device based on the occurrence of the one or more events.

According to various aspects of the subject technology, a machine-readable medium comprising instructions for a method of automatically presenting reminders is provided. The method comprises determining a reminder specified by a user. The reminder comprises one or more terms specified by the user. The method also comprises comparing the one or more terms specified by the user to a set of event terms associated with a plurality of predetermined events. The method also comprises selecting one or more events from the plurality of predetermined events relevant to the reminder based on the comparison of the one or more terms specified by the user to the set of event terms. The method also comprises detecting an occurrence of the one or more events relevant to the reminder. The method also comprises automatically presenting the reminder via an electronic device based on the occurrence of the one or more events relevant to the reminder.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of an arrangement in which reminders may be automatically presented to a user, in accordance with various aspects of the subject technology.

FIG. 2 illustrates an example of a system for automatically presenting reminders, in accordance with various aspects of the subject technology.

FIG. 3 illustrates an example of a method for automatically presenting reminders, in accordance with various aspects of the subject technology.

FIG. 4 illustrates an example of a situation in which a reminder is automatically presented to the user based on a presentation time, in accordance with various aspects of the subject technology.

FIG. 5 illustrates an example of a situation in which a reminder is automatically presented to the user based on a presentation action associated with an application, in accordance with various aspects of the subject technology.

FIG. 6 illustrates an example of a situation in which a reminder is automatically presented to the user based on a presentation location, in accordance with various aspects of the subject technology.

FIG. 7 conceptually illustrates an electronic system with which any implementations of the subject technology are implemented.

### DETAILED DESCRIPTION

In the following detailed description, numerous specific details are set forth to provide a full understanding of the subject technology. It will be apparent, however, that the subject technology may be practiced without some of these specific details. In other instances, structures and techniques have not been shown in detail so as not to obscure the subject technology.

According to various aspects of the subject technology, systems and methods are provided for automatically presenting reminders when one or more relevant events occur. The reminders may be presented without requiring a user to specify all the different times that the reminders should be presented. In some aspects, systems and methods are provided to automatically determine one or more events relevant to a particular reminder recorded by the user. The one or more events may be analyzed, and when an event that is relevant to the reminder occurs, the reminder may be automatically presented to the user. In some aspects, contextual information that is relevant to the reminder may be extracted from different sources and be presented to the user together with the reminder.

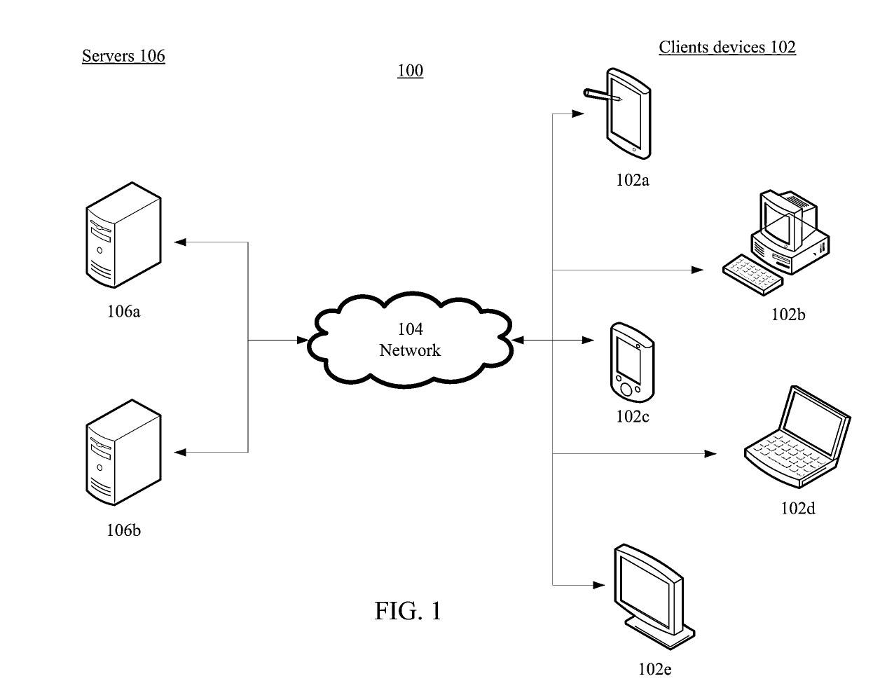

FIG. 1 illustrates an example of arrangement 100 in which reminders may be automatically presented to a user, in accordance with various aspects of the subject technology. Arrangement 100 includes servers 106 (e.g., servers 106a and 106b) and client devices 102 (e.g., client devices 102a, 102b, 102c, 102d, and 102e) connected over network 104. Network 104 can include, for example, any one or more of a personal area network (PAN), a local area network (LAN), a campus area network (CAN), a metropolitan area network (MAN), a wide area network (WAN), a broadband network (BBN), a peer-to-peer network, an ad-hoc network, the Internet, and the like. Further, network 104 can include, but is not limited to, any one or more network topologies such as a bus network, a star network, a ring network, a mesh network, a star-bus network, tree or hierarchical network, and the like.

Reminders, for example, may be automatically presented to the user via one or more of client devices 102 used by the user. Client devices 102 and servers 106 can be any electronic device having processing hardware, memory, and communications capability necessary to perform some or all of the operations disclosed herein. Client devices 102, for example, can be desktop computers (e.g., client device 102b), mobile computers (e.g., client device 102d), tablet computers (e.g., including e-book readers such as client device 102a), mobile devices (e.g., smartphones or personal digital assistants such as client device 102c), set top boxes (e.g., for a television with one or more processors coupled thereto and/or embedded therein such as client device 102e), video game consoles, or any other electronic devices having memory, processing hardware, and communications capabilities for automatically presenting reminders to a user according to certain aspects of this disclosure.

In some aspects, the user may record a reminder using a particular client device 102, and the reminder may automatically be presented to the user via another client device 102. For example, a user may record a reminder using client device 102b. Servers 106 may be able to receive this reminder over network 104, and provide this reminder to client device 102c (e.g., another device that the user is currently using) when a relevant event occurs. The reminder may then be automatically presented to the user via client device 102c when the relevant event occurs. Thus, the user can be presented with a reminder using any client device 102, even if the user only uses a particular client device 102 to record the reminder. In some aspects, the user may record the reminder using a particular client device 102, and the reminder may be automatically presented to the user via the same client device 102, with or without the use of servers 106 over network 104.

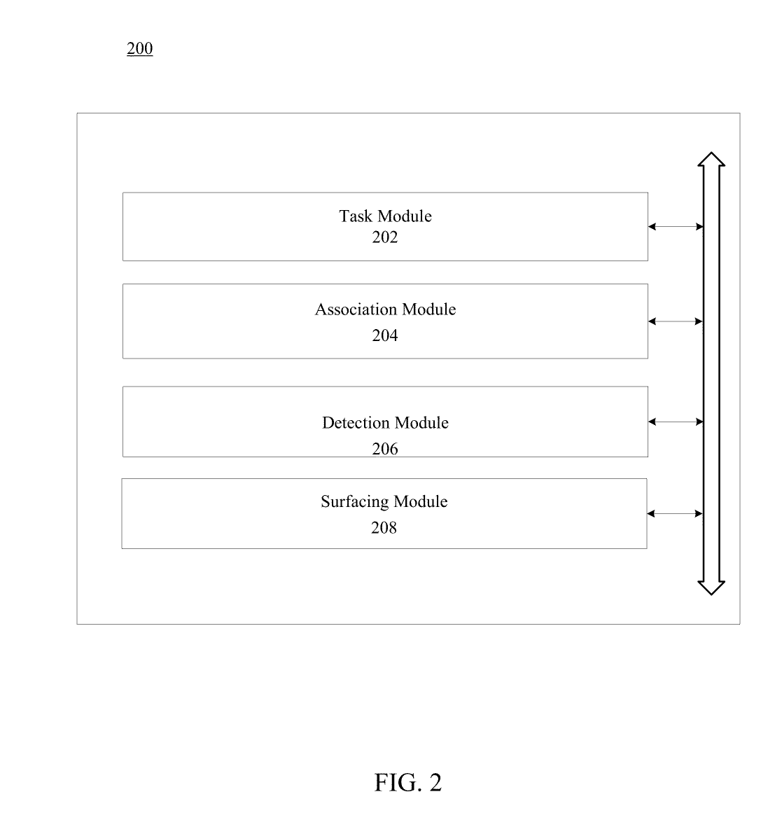

FIG. 2 illustrates an example of system 200 for automatically presenting reminders, in accordance with various aspects of the subject technology. System 200, for example, may be part of client devices 102 and/or servers 106. System 200 comprises task module 202, association module 204, detection module 206, and surfacing module 208. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

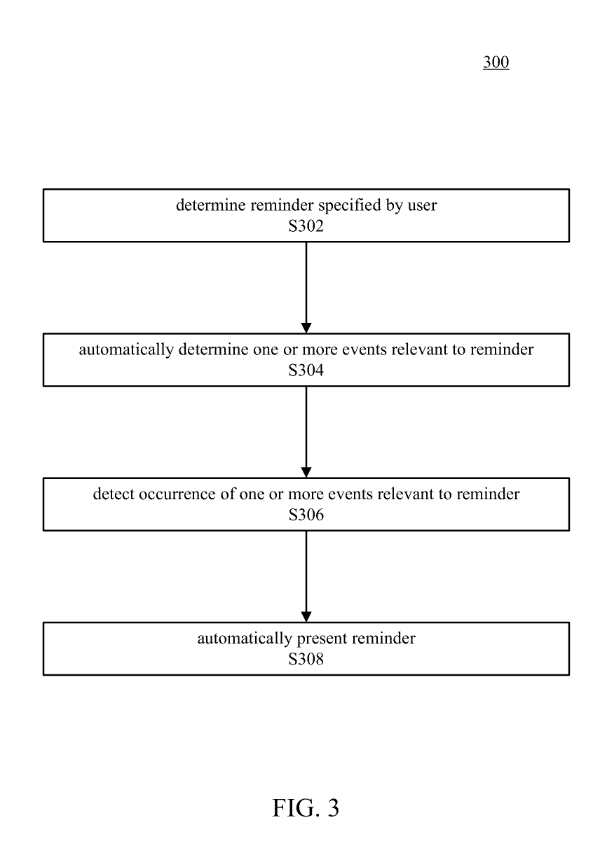

FIG. 3 illustrates an example of method 300 for automatically presenting reminders, in accordance with various aspects of the subject technology. System 200, for example, may be used to implement method 300. However, method 300 may also be implemented by systems having other configurations. Although method 300 is described herein with reference to the examples of FIGS. 1, 2, and 4-7, method 300 is not limited to these examples.

According to step S302, task module 202 determines a reminder specified by the user. The user may record the reminder using a client device 102. For example, the user may record the reminder as an item of a task list or a calendar. The reminder may comprise one or more terms specified by the user. For example, the reminder may indicate a specific phrase comprised of one or more verbs and one or more nouns (e.g., “Call Alex,” “Buy groceries,” “Finish work assignment,” “Email Alice,” etc.). The reminder may also specify a time or place (e.g., “Meet with boss next week,” “Buy memory card from electronics store,” “Alex's birthday is on Monday,” etc.).

According to step S304, association module 204 automatically determines one or more events relevant to the reminder. For example, association module 204 may automatically determine the one or more events relevant to the reminder without requiring the user to specify the one or more events. Thus, the user does not need to waste time and effort to specify which events may be relevant to the reminder. Each of the one or more events may be a presentation time, an arrival by the user at a presentation location, a presentation action associated with an application running on a client device 102, and/or other suitable events relevant to the reminder.

According to certain aspects, the presentation time may be when it is relevant to present the reminder. For example, if the reminder is the user's friend's birthday, association module 204 may determine that the presentation time to be one week before the friend's birthday in order to provide the user with enough time to purchase a gift for the friend. The presentation location may be where it is relevant to present the reminder. Using the previous example, association module 204 may determine the presentation location to be a gift store so that if the user arrives at the gift store, the user may be reminded to purchase a gift for the friend. The presentation action may be what kind of activity, associated with an application running on a client device 102, that may be relevant to presenting the reminder. Using the same example, association module 204 may determine the presentation action to be the user launching a shopping website using a browser on a client device 102 so that the user may be reminded to purchase a gift for the friend's birthday. The application is not limited to a browser, but can include other suitable applications such as productivity tools (e.g., word processing programs, calendar programs, database programs, etc.), social networking programs, multimedia programs (e.g., for video, audio, and/or image editing and/or playback, etc.), communication programs (e.g., email programs, phone/contacts programs, texting programs, etc.), and the like. The presentation action is not limited to launching a particular component of an application, but can include other suitable actions such as surfing, scrolling, opening, and closing a component of the application (e.g., a document, a tab, a contact page, an email, etc.) and/or the application itself.

Association module 204 may determine the one or more events relevant to the reminder in various ways. For example, the one or more events may be part of a plurality of predetermined events stored in servers 106 and/or client devices 102. Depending on the reminder, association module 204 may select which of the plurality of predetermined events is relevant to the reminder. Association module 204, for example, may perform this selection by using one or more categories associated with each of the plurality of predetermined events.

According to certain aspects, each of the plurality of predetermined events may be associated with one or more categories. Each category may specify which area that a corresponding event is relevant to. For example, a category may be an action category, a shopping category, a timing category, a location category, a contacts category, and/or another suitable category that may specify an area relevant to a particular reminder. Association module 204 may select which of the plurality of predetermined events is relevant to the reminder by determining whether the reminder (e.g., comprising one or more terms specified by the user) matches the one or more categories associated with each of the plurality of predetermined events. For example, if association module 204 determines that the reminder matches a particular category, then association module 204 may determine that one or more events associated with that particular category is relevant to the reminder.

Events associated with an action category, for example, may be relevant to reminders in connection with performing a particular action, such as reminders for buying a product, calling a friend, writing a paper, etc. In this regard, events associated with the action category can include events such as the user arriving at a store, launching a shopping website, opening a phone/contacts application on a smartphone, opening a word application, and/or other suitable events.

Events associated with the shopping category, for example, may be relevant to reminders in connection with buying a particular product or attending a particular function in which a gift may be needed. In this regard, events associated with the shopping category can include events such as a predetermined time before the particular function, or the user arriving at a store, launching a shopping website, and/or other suitable events.

Events associated with the timing category, for example, may be relevant to reminders in connection with a particular time, such as reminders for calling a friend on a particular day, picking up laundry on a particular day, a friend's birthday, an anniversary, etc. In this regard, events associated with the timing category can include events such as various predetermined times before the particular time specified by the reminder.

Events associated with the location category, for example, may be relevant to reminders in connection with a particular location, such as reminders for meeting a friend at school, sending an email at work, buying food at a particular restaurant, etc. In this regard, events associated with the location category can include events such as the user arriving at school, the user arriving at work, the user arriving at the particular restaurant, the user launching a mapping application, and/or other suitable events.

Events associated with the contacts category, for example, may be relevant to reminders in connection with a particular contact, such as reminders for returning an item to a person, picking up the person, telling the person something specific, etc. In this regard, events associated with the contacts category can include events such as the user being within the vicinity of the person, the user calling the person, the user emailing the person, and/or other suitable events.

Although categories may be used to determine the one or more events relevant to the reminder as described above, there may be other ways for determining the one or more events relevant to the reminder. For example, association module 204 may compare the one or more terms of the reminder to event terms associated with an event, and determine whether this event is relevant to the reminder based on the comparison. Event terms may be words, phrases, and/or other terms that describe an event and/or are part of the event. For example, if the user is surfing a shopping website for shoes, the shopping website may contain event terms such as “buy,” “sale,” “shoes,” “sandals,” etc. Thus, if the reminder is “Buy a pair of shoes,” association module 204 can compare the terms “buy” and “shoes” from the reminder to the event terms on the shopping website, and determine that the user surfing this website may be an event that is relevant to the reminder (e.g., since the terms of the reminder are related to the event terms in the website).

According to step S306, detection module 206 detects an occurrence of the one or more events relevant to the reminder (e.g., determined in step S304). The user may be provided with an opportunity to control whether any activity of the user (e.g., in using a client device 102) may be analyzed. Should the user consent to such an analysis, detection module 206 may analyze the user's activity in order to detect the occurrence of the one or more events relevant to the reminder. For example, detection module 206 may analyze the location of a client device 102 being used by the user, and if this device arrives at the presentation location, detection module 206 may detect this arrival as an occurrence of an event relevant to the reminder. Detection module 206 may also analyze activity with an application running on a client device 102 in order to detect for any occurrences of the one or more events relevant to the reminder (e.g., the launch of a shopping website, the opening of a word document, etc.).

According to step S308, surfacing module 208 automatically presents the reminder via a client device 102 being used by the user based on the occurrence of the one or more events relevant to the reminder (e.g., as detected in step S306). For example, surfacing module 208 automatically presents the reminder if detection module 206 detects the occurrence of the one or more events relevant to the reminder. Surfacing module 208 may present the reminder in a number of ways, such as displaying the reminder to the user on a screen of a client device 102 being used by the user and/or playing an audio reminder using one or more speakers of this device. Controls may also be provided to allow the user to adjust how frequently reminders should be presented.

According to certain aspects, surfacing module 208 may not only present the reminder to the user, but may also present other contextual information relevant to the reminder. The contextual information may be information that provides context to the user when the reminder is presented to the user. For example, the contextual information may comprise contact information (e.g., a person's name, phone number, email address, instant messaging name, location, etc.), social information (e.g., a person's status, interests, hobbies, etc.), price information (e.g., price of a product from one or more sources, discount code available for the product, suggestions for different products, different stores or sites for purchasing the same product, different prices for the same product, etc.), mapping information (e.g., route information, location information, traffic information, etc.), weather information, and/or other information useful for providing context to the user when presenting the reminder. Association module 204 may automatically determine contextual information relevant to the reminder. In some aspects, association module 204 may automatically determine the contextual information relevant to the reminder without requiring the user to specify the contextual information. For example, association module 204 may automatically determine the contextual information in response to the occurrence of the one or more events being detected.

Association module 204 may determine the contextual information by comparing the one or more terms of the reminder to a set of contextual terms associated with the contextual information, and determine the contextual information based on this comparison. Contextual terms may be words, phrases, and/or other terms that describe contextual information and/or are a part of the contextual information. For example, the user may have a social networking friend named Alex. Alex's social information may be the contextual information, and may include his name, hobbies, interests, contact information, and other information. The words and/or phrases describing his name, hobbies, interests, and contact information, for example, may be contextual terms. Thus, if the user's reminder is “Buy a gift for Alex,” association module 204 can compare the terms “Alex,” “buy,” and “gift” from the reminder to the contextual terms of Alex's social information, and determine that Alex's hobbies and interests may be contextual information relevant to the reminder (e.g., since the terms of the reminder are related to the contextual terms of Alex's social information). Thus, surfacing module 208 may present the reminder as well as Alex's hobbies and interests information to the user. The user and any person associated with the contextual information (e.g., Alex) may be provided with an opportunity to control whether any information may be used by association module 204 to determine the contextual information. Should the user and this person consent to this use, the contextual information may be determined as described above.

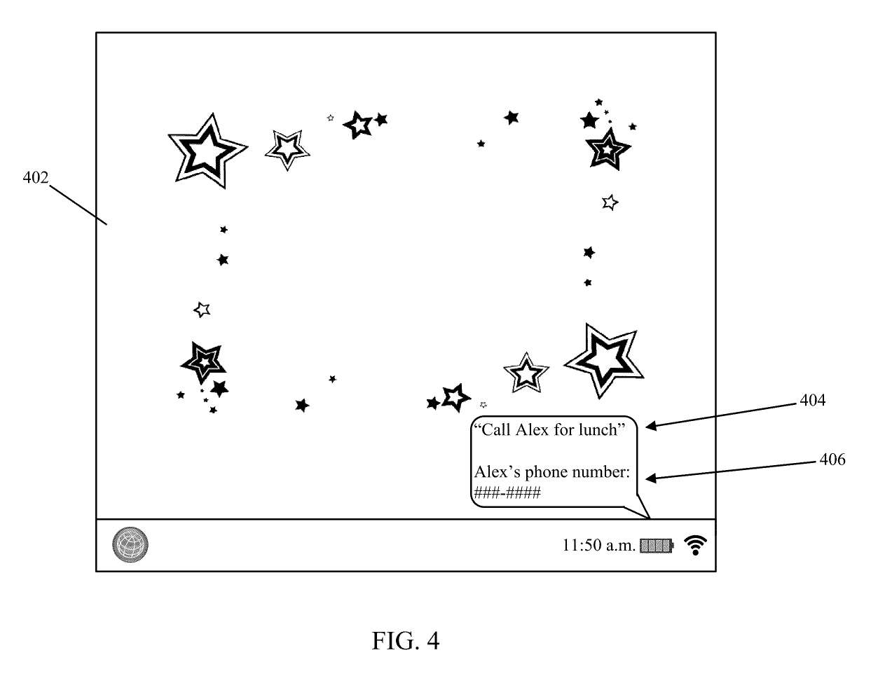

FIG. 4 illustrates an example of a situation in which a reminder is automatically presented to the user based on a presentation time, in accordance with various aspects of the subject technology. FIG. 4 illustrates a screen of client device 102b being used by the user. In particular, FIG. 4 illustrates desktop 402 of client device 102b. In this example, reminder 404 may be determined as “Call Alex for lunch.” Association module 204 may determine that since the purpose of reminder 404 is to call Alex for lunch, an event relevant to reminder 404 may be a presentation time that is briefly before noon (e.g., ten minutes before noon). Association module 204 may also determine Alex's phone number as contextual information 406. Detection module 206 may detect the occurrence of the presentation time (e.g., 11:50 a.m.). If detected, surfacing module 208 may present reminder 404 together with contextual information 406.

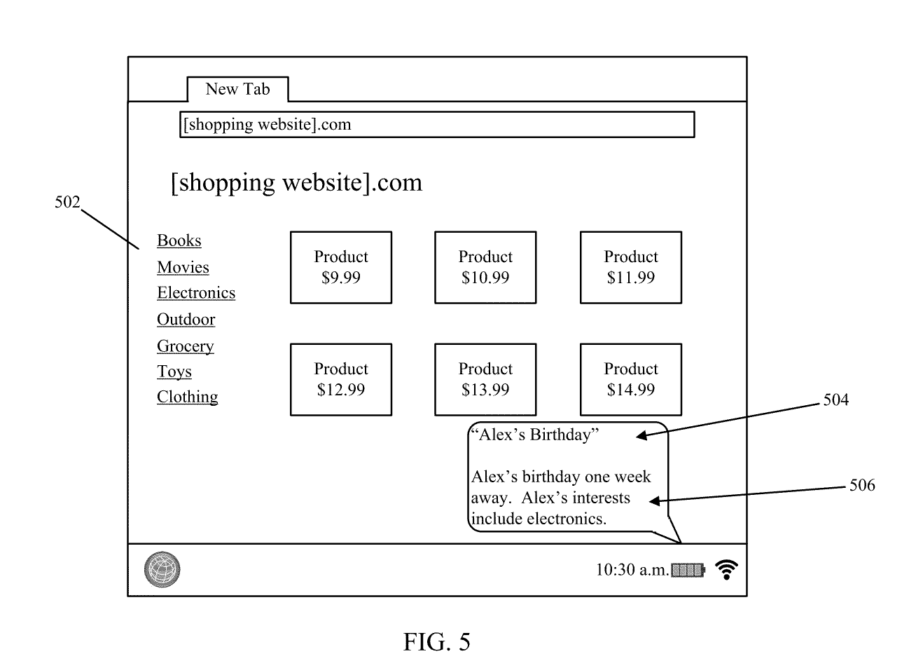

FIG. 5 illustrates an example of a situation in which a reminder is automatically presented to the user based on a presentation action associated with an application, in accordance with various aspects of the subject technology. FIG. 5 illustrates a screen of client device 102b being used by the user. In particular, FIG. 5 illustrates web browser 502 being used by the user on client device 102b to browse a shopping website. In this example, reminder 504 may be determined as “Alex's Birthday.” Association module 204 may determine that since the reminder is for Alex's birthday, an event relevant to reminder 504 may be the user launching and/or surfing a shopping website (e.g., so that the user may be reminded to buy a gift for Alex's birthday). Association module 204 may also determine Alex's birth date and interests as contextual information 506. Detection module 206 may detect the occurrence of when the user launches and/or surfs a shopping website. If detected, surfacing module 208 may present reminder 504 and contextual information 506 to the user, thereby reminding the user to purchase a gift for Alex's birthday.

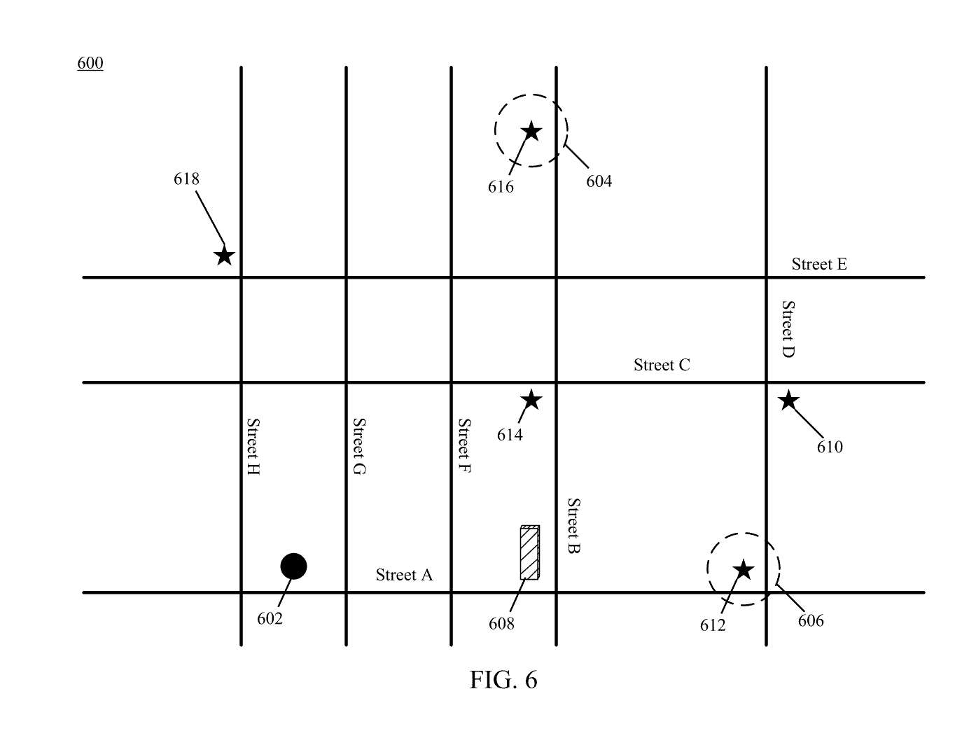

FIG. 6 illustrates an example of a situation in which a reminder is automatically presented to the user based on a presentation location, in accordance with various aspects of the subject technology. FIG. 6 illustrates map 600 that shows location 602 of the user and various points of interest 608, 610, 612, 614, 616, and 618. These points of interest may represent restaurants, stores, gas stations, parks, and/or other suitable places. For example, points of interest 612 and 616 may represent electronics stores. If the reminder is the same as the previous example (e.g., reminder 504), association module 204 may determine that an event relevant to reminder 504 may be the user arriving at an electronics store (e.g., so that the user may be reminded to buy a gift for Alex's birthday). Detection module 206 may analyze the location of the user (e.g., using global positioning system (GPS) coordinates from a client device 102 being used by the user) and detect when the user arrives within the vicinity of points of interest 612 or 616 (e.g., within areas 604 and 606). If detected, surfacing module 208 may present reminder 504 and contextual information 506 to the user (e.g., on the client device 102 being used by the user), thereby reminding the user to purchase a gift for Alex's birthday.

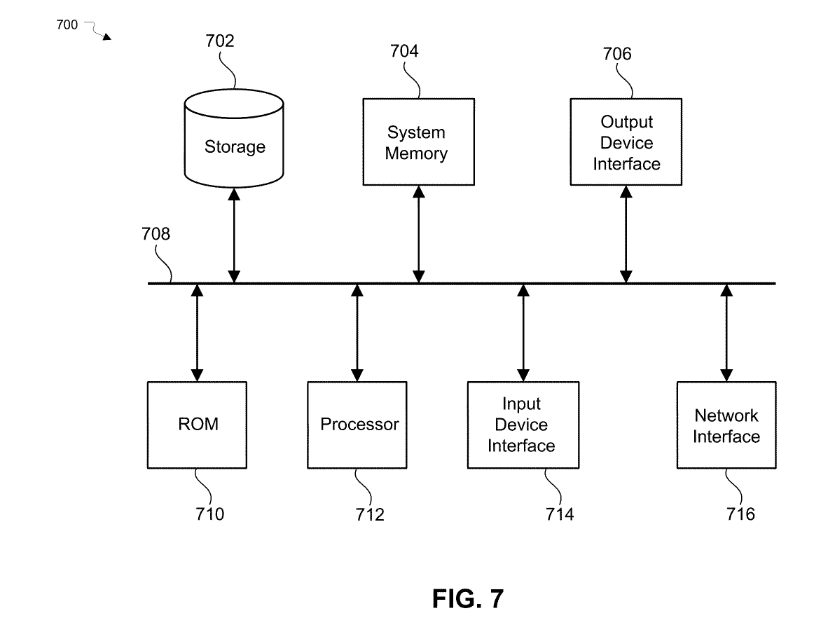

FIG. 7 conceptually illustrates electronic system 700 with which any implementations of the subject technology are implemented. Electronic system 700, for example, can be any of servers 106 and/or client devices 102, or generally any electronic device that transmits signals over a network. Such an electronic system includes various types of computer readable media and interfaces for various other types of computer readable media. Electronic system 700 includes bus 708, processing unit(s) 712, system memory 704, read-only memory (ROM) 710, permanent storage device 702, input device interface 714, output device interface 706, and network interface 716, or subsets and variations thereof.

Bus 708 collectively represents all system, peripheral, and chipset buses that communicatively connect the numerous internal devices of electronic system 700. In one or more implementations, bus 708 communicatively connects processing unit(s) 712 with ROM 710, system memory 704, and permanent storage device 702. From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. One or more implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such as random access memory. System memory 704 stores any of the instructions and data that processing unit(s) 712 needs at runtime. In one or more implementations, the processes of the subject disclosure are stored in system memory 704, permanent storage device 702, and/or ROM 710. From these various memory units, processing unit(s) 712 retrieves instructions to execute and data to process in order to execute the processes of one or more implementations.

Bus 708 also connects to input and output device interfaces 714 and 706. Input device interface 714 enables a user to communicate information and select commands to the electronic system. Input devices used with input device interface 714 include, for example, alphanumeric keyboards and pointing devices (also called “cursor control devices”). Output device interface 706 enables, for example, the display of images generated by electronic system 700. Output devices used with output device interface 706 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, bus 708 also couples electronic system 700 to a network (not shown) through network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to analyze and control an operation or a component may also mean the processor being programmed to analyze and control the operation or the processor being operable to analyze and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A system for automatically presenting reminders, the system comprising:
one or more processors; and
a machine-readable medium comprising instructions stored therein, which when executed by the one or more processors, cause the one or more processors to perform operations comprising:
determining a reminder specified by a user;
automatically determining one or more events relevant to the reminder without requiring the user to specify the one or more events relevant to the reminder;
detecting an occurrence of the one or more events; and
automatically presenting the reminder via an electronic device based on the occurrence of the one or more events.

2. The system of claim 1, wherein the reminder comprises one or more terms specified by the user.

3. The system of claim 1, wherein each of the one or more events comprises at least one of a presentation time, an arrival by the user at a presentation location, and a presentation action associated with an application running on the electronic device.

4. The system of claim 3, wherein the reminder comprises one or more terms specified by the user, wherein the operations further comprise comparing the one or more terms to a set of event terms associated with the one or more events, and wherein the operations further comprise determining at least one of the presentation time, the presentation location, and the presentation action based on the comparison of the one or more terms specified by the user to the set of event terms.

5. The system of claim 3, wherein the application comprises at least one of a productivity tool, a browser, a social networking program, a multimedia program, and a communication program.

6. The system of claim 1, wherein each of the one or more events is associated with a category, wherein the operations further comprise comparing the one or more terms specified by the user to the one or more categories, and wherein the operations further comprise determining the one or more events based on the comparison of the one or more terms specified by the user to the one or more categories.

7. (canceled)

8. The system of claim 1, wherein the operations further comprise presenting the reminder via the electronic device if the occurrence of the one or more events is detected.

9. The system of claim 1, wherein the operations further comprise automatically determining contextual information relevant to the reminder.

10. The system of claim 9, wherein the operations further comprise presenting the reminder together with the contextual information.

11. The system of claim 9, wherein the operations further comprise determining the contextual information in response to the occurrence of the one or more events being detected.

12. The system of claim 9, wherein the reminder comprises one or more terms specified by the user, wherein the operations further comprise comparing the one or more terms specified by the user to a set of contextual terms associated with the contextual information, and wherein the operations further comprise determining the contextual information based on the comparison of the one or more terms specified by the user to the set of contextual terms.

13. The system of claim 9, wherein the contextual information comprises at least one of contact information, social information, price information, route information, location information, traffic information, weather information, and alternative information.

14. The system of claim 9, wherein the operations further comprise determining the-contextual information without requiring the user to specify the contextual information.

15. A computer-implemented method for automatically presenting reminders, the method comprising:
determining a reminder specified by a user;
automatically determining one or more events relevant to the reminder without requiring the user to specify the one or more events relevant to the reminder;
detecting an occurrence of the one or more events; and
automatically presenting the reminder via an electronic device based on the occurrence of the one or more events.

16. The method of claim 15, wherein each of the one or more events comprises at least one of a presentation time, an arrival by the user at a presentation location, and a presentation action associated with an application running on the electronic device.

17. The method of claim 16, wherein the reminder comprises one or more terms specified by the user, and wherein automatically determining the one or more events comprises:
comparing the one or more terms specified by the user to a set of predetermined reminder terms; and
determining at least one of the presentation time, the presentation location, and the presentation action based on the comparison of the one or more terms specified by the user to the set of predetermined reminder terms.

18. A non-transitory machine-readable medium comprising instructions for a method of automatically presenting reminders, the method comprising:
determining a reminder specified by a user, the reminder comprising one or more terms specified by the user;
comparing the one or more terms specified by the user to a set of event terms associated with a plurality of predetermined events;
selecting one or more events from the plurality of predetermined events relevant to the reminder based on the comparison of the one or more terms specified by the user to the set of event terms;
detecting an occurrence of the one or more events relevant to the reminder; and
automatically presenting the reminder via an electronic device based on the occurrence of the one or more events relevant to the reminder.

19. The non-transitory machine-readable medium of claim 18, wherein the method further comprises automatically determining contextual information relevant to the reminder.

20. The non-transitory machine-readable medium of claim 19, wherein the contextual information is automatically determined in response to the occurrence of the one or more events being detected.
